(19) United States
(12) Patent Application Publication
(10) Pub. No.: US 2011/0142240 A1
(43) Pub. Date: Jun. 16, 2011

(54) METHOD AND TERMINAL FOR LAWFUL INTERCEPTION

(75) Inventors: Byungsik YOON, Daejeon (KR); Song In Choi, Daejeon (KR); Sook Jin Lee, Daejeon (KR); Jee Kwan Ahn, Daejeon (KR)

(73) Assignee: Electronics and Telecommunications Research Institue, Daejeon (KR)

(21) Appl. No.: 12/884,861

(22) Filed: Sep. 17, 2010

(30) Foreign Application Priority Data
Dec. 15, 2009 (KR) 10-2009-0124793

(51) Int. Cl. H04L 9/08; G06F 15/16; G06F 21/00

(52) U.S. Cl. 380/278; 709/242; 726/3

(57) ABSTRACT

An interception target terminal includes an interception module, and the interception module activates an interception function on the basis of interception related information received from a communication business system. In addition, when a communication mode is changed in the state where an interception function is in an activated state, if a network to be accessed depending on a change of the communication mode is a network that is permitted to be intercepted, corresponding access details information is transmitted to a communication service system or a law enforcement agency system. Further, when the terminal performs communication by an encryption method in the state where the interception function is in the activated state, an encryption key used for encryption or communication data before the encryption is transmitted to the communication service system or the law enforcement agency system.

### CROSS-REFERENCE TO RELATED APPLICATION

This application claims priority to and the benefit of Korean Patent Application No. 10-2009-0124793 filed in the Korean Intellectual Property Office on Dec. 15, 2009, the entire contents of which are incorporated herein by reference.

### BACKGROUND OF THE INVENTION

(a) Field of the Invention

The present invention relates to a method and a terminal for lawful interception.

(b) Description of the Related Art

In recent years, as communication systems have rapidly developed, efficient interception cannot be achieved by only wire tapping. Therefore, a lawful interception (hereinafter, referred to as “LI”) method has been proposed and administrated in the U.S.A., Europe, etc., to suit the rapidly developed communication systems.

In particular, the U.S. Congress enacted the Communications Assistance for Law Enforcement Act (CALEA) in 1994, and regulated that telecommunication/service providers should cooperate in lawful interception. In addition, since the 9.11 terrorist attack, lawful interception has been further strengthened by the passing of the Patriot Act as a precaution against various crimes and terrorist acts. The European Parliament that consists of members of the European Union (EU) enacted the Cyber-Crime Act as a method for lawful interception for the rapidly developing communication systems, and the member nations of the European Union are performing lawful interception on the basis of the Act.

Further, in the U.S.A. and European nations, law enforcement agencies and telecommunication/service providers have standardized a lawful interception procedure regarding a law concerning interception. Representative standards include the standard of J-STD-025-A-2003 enacted by the Telecommunication Industry Association (TIA) in the U.S.A. and the standard of TS 101 671 enacted by the European Telecommunication Standard Institute (ETSI) in Europe.

In general, a lawful interception agency performing the lawful interception is issued with a lawful interception warrant on a predetermined user from the court, and notifies this to the telecommunication/service providers. Therefore, the telecommunication/service provider directs a mediation device to perform interception through administration of the LI. Herein, the mediation device assigns an interception target to an intercepting control element (hereinafter referred to as “ICE”) that takes charge of authentication of a subscriber or charging and collects various intercept related information (hereinafter referred to as “IRI”). The IRI includes charging information of the interception target, call processing information, IP address information, telephone number information, calling list information, etc. The mediation device formats the collected IRI to be suitable for a predetermined agreed interface, and transmits the formatted IRI to the lawful interception agency in the format of communication identifying information (hereinafter referred to as “CmII”).

In addition, in the case when a calling list or interception of presently transmitted communication contents are needed, the mediation device requests actual interception of communication contents to the intercepting network element (hereinafter referred to as “INE”) that takes charge of actual transmission of the communication contents. Therefore, when the interception target performs communication, the ICE that recognizes it transmits communication information of the interception target to the INE, and the INE transmits communication contents by copying a calling list of the interception target from the received communication information of the interception target to the mediation device. Further, the mediation device formats the relevant communication contents to be suitable for the predetermined agreed interface, and transmits the formatted communication contents to the lawful interception agency in the format of the communication contents (hereinafter referred to as “CC”).

Meanwhile, in the case where the interception target changes the access from a subscriber identification wireless communication such as a mobile communication system or wireless broadband (WiBro), Netspot, etc., where interception is easy, to a common wireless Internet widely used in recent years, it is impossible to acquire communication records from the law enforcement agency by using the above-mentioned lawful interception method. Further, even when a predetermined interception target uses a strongly encrypted conversation program, the law enforcement agency cannot break the encryption and has a limit in efficient countermeasures.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for lawful interception that is capable of performing efficient lawful interception even when an interception target changes a communication mode of the terminal in order to evade lawful interception and performing the lawful interception in real time even when the interception target performs communication by an encryption method, and a terminal for performing the lawful interception.

An exemplary embodiment of the present invention provides a terminal that includes:

an interception related information database storing interception related information including an interception range and an interception validity period received from a communication service system providing a communication service; and an interception module that determines whether or not an interception function is activated on the basis of the interception related information, and transmits access details information corresponding to a network to be accessed when the interception function is in an activated state at the time of changing a communication mode and the network to be accessed is a network on which interception is permitted to a law enforcement agency system acquiring an interception right or the communication service system.

Another embodiment of the present invention provides a method in which a terminal performs lawful interception in link with a communication service system providing a communication service, that includes:

receiving interception related information including an interception validity period and an interception range from the communication service system; determining whether or not to activate an interception function on the basis of the interception related information; when the communication mode of the terminal is changed to the state where the interception function is in an activated state, verifying whether or not interception of a network to be accessed is permitted to correspond to the changed communication mode on the interception related information; and transmitting access details information corresponding to the network to be accessed to a law enforcement agency system acquiring a lawful interception right or the communication service system when the network to be accessed is a network that is permitted to be intercepted.

Yet another embodiment of the present invention provides a method in which a terminal performs lawful interception in link with a communication service system providing a communication service, that includes:

receiving interception related information including an interception validity period and an interception range from the communication service system; determining whether or not to activate an interception function on the basis of the interception related information; and when the terminal performs the communication by the encryption method in the state where the interception function is activated, transmitting an encryption key used to encrypt communication data or communication data before the encryption to a law enforcement agency system acquiring an interception right or the communication service system.

Still another embodiment of the present invention provides a method in which a communication service system providing a communication service performs lawful interception in link with an interception terminal, that includes:

receiving an interception request including interception target information from a law enforcement agency system acquiring a lawful interception right; transmitting interception related information including an interception validity period and an interception range to the interception terminal corresponding to the interception target information; when the interception terminal accesses a network accessible without authentication of the communication service system, receiving access details information corresponding to the network that the interception terminal accesses from the interception terminal; and collecting interception information on the interception terminal on the basis of the access details information.

### BRIEF DESCRIPTION OF THE DRAWINGS

FIG. 1 is a configuration diagram schematically showing an interception system according to an embodiment of the present invention;

FIG. 2 is a flowchart showing an interception method according to an embodiment of the present invention, and shows a case where an interception terminal activates an interception function;

FIG. 3 is a flowchart showing an interception method according to an embodiment of the present invention, and shows a case where an interception terminal changes a communication mode; and

FIG. 4 is a flowchart showing an interception method according to an embodiment of the present invention, and shows a case where an interception terminal performs a communication by an encryption method.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), an access terminal (AT), etc., and may include the entire or partial functions of the mobile station, the mobile terminal, the subscriber station, the portable subscriber station, the user equipment, the access terminal, etc.

Hereinafter, a method and a terminal for lawful interception according to an embodiment of the present invention will be described in detail with reference to the accompanying drawings.

Hereinafter, a terminal serving as a lawful interception target is referred to as “interception target”, and a system of an agency that acquires a lawful interception authority for the interception terminal is referred to as “law enforcement agency system”. Further, a business system that provides communication services such as a mobile communication service, a subscriber identification wireless Internet service, a common wireless Internet service, etc. is referred to as “communication service system”.

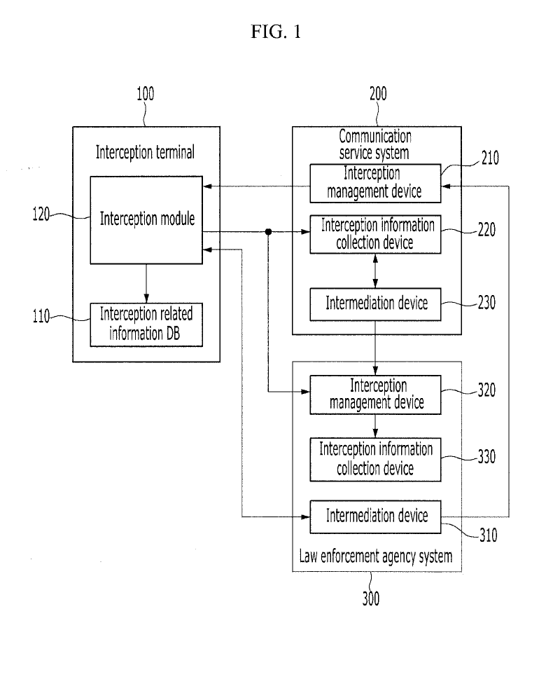

FIG. 1 is a configuration diagram schematically showing an interception system according to an embodiment of the present invention.

Referring to FIG. 1, an interception terminal 100 includes an interception related information database (hereinafter referred to as “DB”) 110 and an interception module 120.

The interception related information DB 110 stores an interception range of the lawful interception, an interception identifier (ID), an interception validity period, etc.

The interception module 120 receives interception related information from a communication service system 200, and stores the received interception related information in the interception related information DB 110. Herein, the interception module 120 performs an authentication process for the interception related information in link with the law enforcement agency system 300 before storing the received interception related information. In addition, only when the interception related information is authenticated by a law enforcement agency system 300, the interception related information is stored in the interception related information DB 110, and thereafter, whether the interception function is activated is determined based on the interception related information.

Further, when the interception terminal 100 wants to access a network on which the communication service can be used without authentication of the communication service system 200, such as the public network, etc., by changing the communication mode in the state where the interception function is activated, the interception module 120 verifies whether or not a network to be accessed is a network that is permitted to be intercepted on the basis of the interception range included in the interception related information. In addition, when the network to be accessed is permitted to be intercepted, access details information of the interception terminal 100 is collected and transmitted to the communication service system 200 or the law enforcement agency system 300. Herein, the access details information that the interception module 120 collects includes a MAC address, an IP address, positional information of the interception terminal 100, and an interception ID that the interception terminal 100 uses to access the public network. The interception module 120 transmits the access details information collected as a predetermined target of the communication service system 200 and the law enforcement agency system 300.

Further, when the interception terminal 100 performs the communication by the encryption method in the state where the interception function is activated, the interception module 120 transmits an encryption key used to encrypt communication data or communication data before encryption to the predetermined target of the communication service system 200 and the law enforcement agency system 300.

The communication service system 200 includes an interception management device 210, an interception information collection device 220, and an intermediation device 230.

When the interception management device 210 receives an interception request including the interception information, the interception range, the interception ID, the interception validity period, etc. from the law enforcement agency system 300, the interception management device 210 transmits the interception related information to the interception terminal 100 on the basis of the received interception request.

The interception information collection device 220 collects communication identification information CmII for the interception terminal 100 and interception information including the communication data CC. Herein, the communication identification information may include communication counterpart information on the interception terminal 100, billing information, positional information of the interception target, etc.

Meanwhile, an interception information collection method of the interception information collection device 220 depends on whether or not a network that the interception terminal 100 accesses to use the communication service is a network requiring authentication of the communication service system 200 and whether or not the interception terminal 100 performs the communication by the encryption method. That is, the interception information collection method of the interception information collection device 220 depends on whether or not the interception information collection device 220 can verify that the interception terminal 100 accesses the network and whether or not the communication data of the interception terminal 100 is encrypted and transmitted.

First of all, when the communication service system 200 can verify the access details of the interception terminal 100 by the interception terminal 100's accessing the mobile communication network requiring authentication by the communication service system 200 or the subscriber identification wireless Internet, the interception information collection device 220 collects the communication identification information CmII corresponding to the communication service access details from a communication generation time of the interception terminal 100 that is the interception target through remote authentication dial-in user services (RADIUS)/a dynamic host configuration protocol (DHCP) server. In addition, the interception information collection device 220 collects the communication data CC corresponding to call records from the communication generation time of the interception terminal 100 through a router, etc.

On the contrary, the interception terminal 100 uses the communication service by accessing the public network in order to evade the interception of the communication service system 200, such that the communication service system 200 cannot verify network accessing of the interception terminal 100. At this time, the communication service system 200 receives the access details information from the interception terminal 100 in order to intercept the interception terminal 100. In addition, the communication service system 200 collects the communication identification information of the interception terminal 100 and the communication data CC on the basis of the received access details information.

Further, the interception terminal 100 uses the communication service through the encrypted communication method, such that it is difficult for the communication service system 200 to acquire the communication data of the interception terminal 100 in real time. At this time, the interception information collection device 220 receives the encryption key or the communication data CC from the interception terminal 100. In addition, when the interception information collection device 220 receives the encryption key from the interception terminal 100, the interception information collection device 220 acquires the communication data CC by decoding the encrypted communication data of the interception terminal 100 by using the received encryption key.

The intermediation device 230 converts the interception information (communication identification information CmII and communication data) collected by the interception information collection device 220 into a format that is previously promised with the law enforcement agency system 300, and transmits it to the law enforcement agency system 300.

The law enforcement agency system 300 includes an interception management device 310, a collection device 320, and an analysis device 330.

The interception management device 310 transmits the interception target information to the communication service system 200 when a warrant for the interception target is issued and thus the lawful interception is permitted. Further, the interception management device 310 performs authentication for the authentication related information of the interception terminal 100 in link with the interception terminal 100.

The collection device 320 collects the interception information (communication identification information CmII and communication data CC) from the communication service system 200 or collects the communication data CC of the interception terminal 100 or the encryption key and the encrypted communication data from the interception terminal 100.

Herein, when the collection device 320 collects the encryption key and the encrypted communication data from the interception terminal 100, the collection device 320 decodes the communication data CC by using the collected encryption key.

The analysis device 330 performs interception for the interception target by analyzing the collected interception information for the interception target.

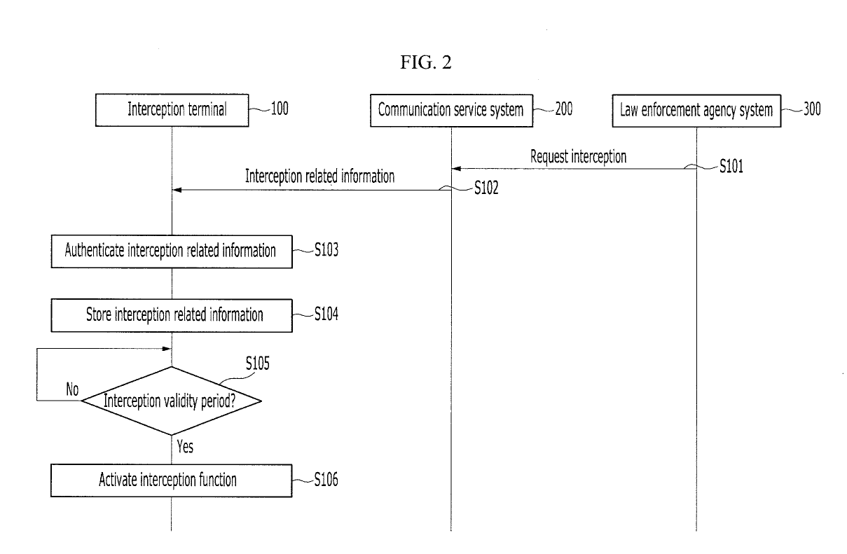

FIG. 2 is a flowchart showing an interception method according to an embodiment of the present invention, and shows a case where an interception terminal activates an interception function.

Referring to FIG. 2, when the warrant for the interception target is issued, the law enforcement agency system 300 transmits the interception request including the interception target information for the interception target, the interception range, the interception ID, the interception validity period, etc., to the communication service system 200 (S101). In addition, the communication service system 200 that receives the interception request checks the interception terminal 100 on the basis of the interception target information and transmits the interception related information to the interception terminal 100 (S102). Herein, the interception related information includes the interception range, the interception identifier (ID), the interception validity period, etc., and the communication service system 200 transmits the interception related information to the interception terminal 100 when the interception terminal 100 accesses the network in order to use the communication service. At this time, the communication service system 200 should be able to verify whether or not the interception terminal 100 accesses the network in order to transmit the interception related information to the interception terminal 100. That is, when the interception terminal 100 accesses the network requiring the authentication of the communication service system 200, the interception related information can be transmitted to the interception terminal 100.

The interception terminal 100 that receives the interception related information from the communication service system 200 performs the authentication for the interception related information received in link with the law enforcement agency system 300 (S103). In addition, only when the authentication is successfully performed, the interception related information is stored in the interception related information DB 110 (S104). Thereafter, the interception module 120 of the interception terminal 100 activates the interception function of the interception module when the interception validity period included in the interception related information is reached.

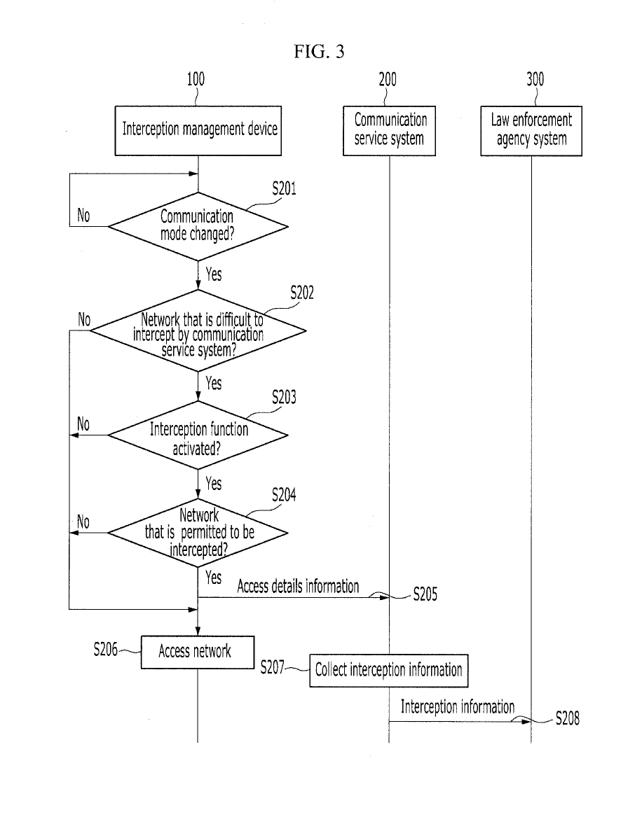

FIG. 3 is a flowchart showing an interception method according to an embodiment of the present invention, and shows a case where an interception terminal changes a communication mode.

Referring to FIG. 3, when the communication mode of the interception terminal 100 is changed (S201), the interception module 120 verifies whether or not a network to be accessed depending on the change of the communication mode is a network on which interception by the communication service system 200 is difficult (S202). That is, the interception module 120 verifies whether or not the network to be accessed is an accessible network without authentication by the communication service system 200. Herein, in order to determine whether or not the network to be accessed is the network on which the interception by the communication service system 200 is difficult, the interception module 120 may verify whether the authentication by the communication service system 200 is required while the interception terminal 100 accesses the network or uses network information pre-stored in the interception terminal 100. Herein, in case of using the pre-stored network information, the interception terminal 100 may previously set, store, and use information on a network on which the interception by the interception by the interception module 120 is required.

According to the verification result, when it is determined that the network to be accessed is the network on which the interception by the communication service system 200 is permitted, it is verified whether or not the interception function of the interception module 120 is in an activated state (S203). In addition, when the interception function of the interception module 120 is in the activated state, it is verified whether or not the network to be accessed is a network on which the interception is permitted on the basis of the interception range (S204). If the network to be accessed is the network on which the interception is permitted, the access details information of the interception terminal 100 is collected and transmitted to the communication service system 200 (S205). Further, the interception terminal 100 performs network accessing on the basis of the changed communication mode (S206).

On the contrary, when the interception function of the interception module 120 is in an inactivated state or the network that the interception terminal 100 accesses is not the network on which the interception by the communication service system 200 is permitted depending on the change of the communication mode, the interception terminal 100 accesses a network corresponding to the changed communication mode without transmitting the access details information to the communication service system 200 (S206).

Meanwhile, the communication service system 200 that receives the access details information of the interception terminal 100 from the interception terminal 100 collects the interception information (communication identification information CmII and the communication data CC) on the interception terminal 100 on the basis of the received access details information (S207). In addition, the collected interception information is converted into the format previously promised with the law enforcement agency system 300 and transmitted to the law enforcement agency system 300 (S208).

Meanwhile, in FIG. 3, although the case where the access details information that the interception terminal 100 collects is transmitted to the communication service system 200 is described as an example, the access details information that the interception terminal 100 collects can also be transmitted to the law enforcement agency system 300 in the present invention. In the present invention, the interception terminal 100 transmits the collected access details information to a predetermined system of the communication service system 200 and the law enforcement agency system 300.

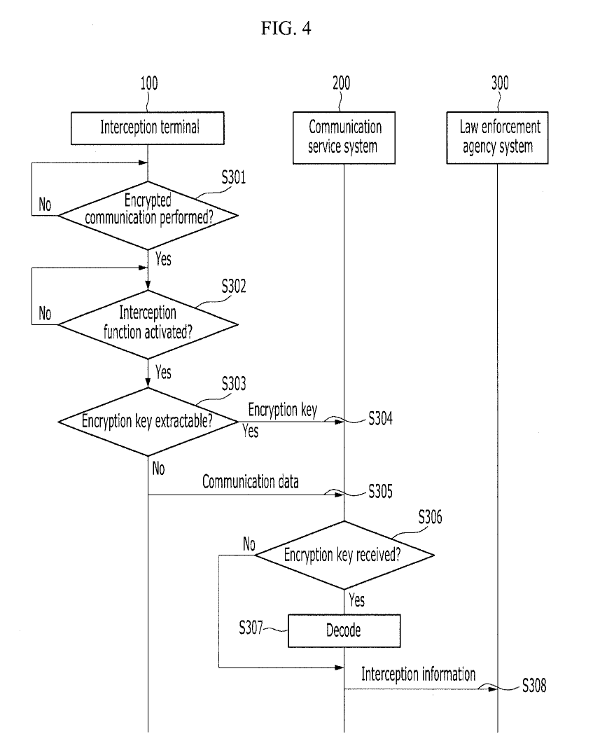

FIG. 4 is a flowchart showing an interception method according to an embodiment of the present invention, and shows a case where an interception terminal performs communication by an encryption method.

Referring to FIG. 4, when the interception terminal 100 performs the communication by the encrypted communication method (S301), the interception module 120, first of all, verifies whether or not the interception function is activated (S302).

In addition, when the interception function is in the activated state, it is verified whether or not the encryption key used to encrypt the communication data is extractable (S303), and when the encryption key is extractable, the extracted encryption key is transmitted to the communication service system 200 (S304). On the contrary, when the encryption key is unextractable, the communication data before encryption is extracted and the extracted communication data is transmitted to the communication service system 200 (S305).

When the encryption key is received from the interception terminal 100 that performs the communication by the encryption method (S306), the communication service system 200 collects the encrypted communication data of the interception terminal 100 and decodes the encrypted communication data of the interception terminal 100 by using the received encryption key (S307). In addition, the interception information including the decoded communication data CC is transmitted to the law enforcement agency system 300 (S308). On the contrary, when not the encryption key but the communication data before the encryption is received from the interception terminal 100 that performs the communication by the encryption method, the communication service system 200 transmits the interception information including the communication data CC received from the interception terminal to the law enforcement agency system 300 without performing the decoding process (S308).

Meanwhile, in FIG. 4, although a case where the interception terminal 100 transmits the encryption key or the communication data before the encryption to the communication service system 200 is described as an example, the interception terminal 100 can also transmit the encryption key or the communication data before the encryption to the law enforcement agency system 300 in the present invention. In the present invention, the interception terminal 100 transmits the encryption key or the communication data before the encryption to a predetermined system of the communication service system 200 and the law enforcement agency system 300.

As described above, in the case of using the interception method according to the embodiment of the present invention, even when the interception terminal 100 accesses the network on which it is difficult to track the interception terminal 100, such as the public network by changing the communication mode, the communication service system 200 can track the interception terminal 100, thereby efficiently intercepting the interception terminal 100.

Further, even when the interception terminal 100 performs the communication by the encryption method, it is possible to acquire the interception information on the interception terminal 100 in real time by receiving the encryption key from the interception terminal 100 or receiving the communication data before the encryption.

According to an embodiment of the present invention, it is possible to perform an efficient interception operation for a network in which it is difficult to track an interception terminal, such as a public network.

Further, even when the interception terminal performs the communication by the encryption method, it is possible to acquire interception information on the terminal serving as the interception terminal in real time.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal, comprising:
an interception related information database storing interception related information including an interception range and an interception validity period received from a communication service system providing a communication service; and
an interception module that determines whether or not an interception function is activated on the basis of the interception related information and transmits access details information corresponding to a network to be accessed when the interception function is in an activated state at the time of changing a communication mode and the network to be accessed is a network on which interception is permitted to a law enforcement agency system acquiring an interception right or the communication service system.

2. The terminal of claim 1, wherein,
when the terminal performs communication by an encryption method in a state where the interception function is activated, the interception module transmits an encryption key used to encrypt communication data to the law enforcement agency system or the communication service system.

3. The terminal of claim 1, wherein,
when the terminal performs the communication in a state where the interception function is in the activated state, the interception module transmits communication data before encryption to the law enforcement agency system or the communication service system.

4. The terminal of claim 1, wherein,
if the network to be accessed is a network that is accessible without authentication by the communication service system, the interception module transmits the access details information to the communication service system or the law enforcement agency system.

5. The terminal of claim 1, wherein
the interception module performs an authentication process of the interception related information in link with the law enforcement agency system.

6. A method in which a terminal performs lawful interception in link with a communication service system providing a communication service, comprising:
receiving interception related information including an interception validity period and an interception range from the communication service system;
determining whether or not to activate an interception function on the basis of the interception related information;
when the communication mode of the terminal is changed in a state where the interception function is in an activated state, verifying whether or not interception of a network to be accessed is permitted to correspond to the changed communication mode on the basis of the interception related information; and
transmitting access details information corresponding to the network to be accessed to a law enforcement agency system acquiring a lawful interception right or the communication service system when the network to be accessed is a network which is permitted to be intercepted.

7. The method of claim 6, further comprising
performing an authentication process of the interception related information in link with the law enforcement agency system.

8. The method of claim 7, wherein
the determining
determines whether or not the interception function is activated on the basis of the interception related information when the interception related information is authenticated by the law enforcement agency system.

9. The method of claim 6, wherein
the verifying includes:
verifying whether or not the interception function is in the activated state when the communication mode is changed; and
verifying whether or not the network to be accessed is permitted to be intercepted on the basis of the interception range when the interception function is in the activated state.

10. The method of claim 6, wherein
the transmitting
transmits the access details information to a predetermined system of the law enforcement agency system and the communication service system.

11. A method in which a terminal performs lawful interception in link with a communication service system providing a communication service, comprising:
receiving interception related information including an interception validity period and an interception range from the communication service system;
determining whether or not to activate an interception function on the basis of the interception related information; and
when the terminal performs the communication by the encryption method in a state where the interception function is activated, transmitting an encryption key used to encrypt communication data or communication data before the encryption to a law enforcement agency system acquiring an interception right or the communication service system.

12. The method of claim 11, wherein
the determining includes
activating the interception function when the interception validity period is reached.

13. The method of claim 11, wherein
the transmitting includes:
extracting the encryption key; and
transmitting the extracted encryption key to the law enforcement agency system or the communication service system.

14. The method of claim 11, wherein
the transmitting includes
transmitting the communication data before the encryption to the law enforcement agency system or the communication service system when it is impossible to extract the encryption key.

15. A method in which a communication service system providing a communication service performs lawful interception in link with an interception terminal, comprising:
receiving an interception request including interception target information from a law enforcement agency system acquiring a lawful interception right;
transmitting interception related information including an interception validity period and an interception range to the interception terminal corresponding to the interception target information;
when the interception terminal accesses a network accessible without authentication by the communication service system, receiving access details information corresponding to the network which the interception terminal accesses from the interception terminal; and
collecting interception information on the interception terminal on the basis of the access details information.

16. The method of claim 15, further comprising
when the interception target terminal performs communication by an encryption method, receiving an encryption key used for encryption or communication data before the encryption from the interception terminal.

17. The method of claim 16, further comprising:
when the encryption key is received from the interception terminal, collecting the encrypted communication data of the interception terminal; and
decoding the encrypted communication data by using the encryption key,
wherein the interception information includes the decoded communication data.

18. The method of claim 16, wherein
the collecting the encrypted communication data includes,
when the communication data before the encryption is received from the interception terminal, including the communication data before the encryption in the interception information.

19. The method of claim 16, wherein
the receiving the access details information includes,
when the interception terminal accesses a network included in the interception range within the interception validity period, receiving the access details information from the interception terminal.

20. The method of claim 16, wherein
the receiving the access details information includes
receiving the access details information including at least one of a MAC address, an IP address, positional information of the interception terminal, and an interception identifier that the interception terminal uses to access the network.
